(19) United States
(12) Patent Application Publication
(10) Pub. No.: US 2019/0232483 A1
(43) Pub. Date: Aug. 1, 2019

(54) Collapsible workbench-table

(71) Applicant: Felix Cruz, Montclair, NJ (US)

(72) Inventor: Felix Cruz, Montclair, NJ (US)

(21) Appl. No.: 15/932,091

(22) Filed: Feb. 1, 2018

(51) Int. Cl. B25H 1/04; B25H 1/16

(52) U.S. Cl. CPC B25H 1/04; B25H 1/08; B25H 1/16

(57) ABSTRACT

A novel workbench-table design is disclosed herein addressing the object of creating a unique workbench-table upon which large power tools, equipment, workpieces, or most any other object(s) can be placed on top of the novel workbench-table. In addition, the unique workbench-table collapses into a closed configuration when two rotatable and detachable vertical support legs are rotated upwards and two of the vertical support legs are rotated downwards.

### CROSS REFERENCES

A Provisional Patent Application covering the invention described herein was filed on Mar. 10, 2017 and assigned Ser. No. 62/469,547.

### BACKGROUND OF THE INVENTION

### 1. Field of the Invention

This novel invention relates to a portable multipurpose collapsible workbench-table. In particular, it addresses the makeup of a unique workbench-table which can be used to place on its top surface many items such as small equipment, work tools, and/or materials to perform such actions as shaping, cutting, gluing, or painting. Further, when the pivoted detachable and rotatable support legs are rotated downwards and upwards, the top and bottom sections can be joined, via a latch mechanism, to collapse the workbench-table into a closed geometric object that resembles a trunk or suitcase. The unique multipurpose workbench-table can also be used as a regular small table or to store tools or other objects when the workbench-table is not being used as a workbench.

### 2. Description of Prior Art

Existing workbenches are mainly of three types. Type I workbenches have a rectangular-shaped top surface which is supported by four vertical support legs which are connected via some form of cross bracing to provide structural support. The height of some Type I workbenches can be adjusted via a hole-pin mechanism which is part of each vertical support leg. Type II workbenches have similar designs as Type I workbenches but are much smaller in overall dimensions and the height of the workbenches cannot be adjusted. Type III workbenches have a top surface section which is subdivided into two smaller top sections. One of the top sections is fixed in position and the other section is allowed, using a spindle mechanism, to move toward or away from the fixed top section. Separating the two top sections creates a small gap in the middle of the workbench which permits limited dimensional materials or workpieces to be locked in place between the two top sections.

One of the main deficiencies of existing workbenches is that the structural stability, especially when used while cutting workpieces, is hindered because the workbenches have only four contact points to the ground. The four-contact points are the bottom tips, a very small surface area, of each of the four vertical support legs and the ground. Other deficiencies of Type I, II and Ill workbenches are: (1) the top surfaces cannot be used as a regular table when workbenches are not being used as workbenches; (2) the workbenches do not collapse into a closed object or closed geometric configuration; (3) the workbenches cannot be used to store objects inside the workbenches and protect the stored objects from external environment(s) or conditions; and (4), most workbenches or work tables are not easy to relocate due to their size and weight.

The proposed novel invention presented herein will solve many of the deficiencies associated with existing workbenches. For instance, because of its compact size, users will be able to work and use the unique workbench-table in confined areas, easily adjust the height of workbench-table flanges to level workpieces and level the work surface area, store tools for easy access, and collapse the workbench-table to easily transport the workbench-table to distant locations. More importantly, the workbench-table will increase the personal safety of users, when users cut or shape workpieces, because the bottom section of this novel workbench-table makes one-hundred percent (100%) contact with the ground. The 100% surface contact with the ground greatly enhances the overall structural stability of the novel workbench-table. Further, because each vertical support leg of this workbench-table is comprised of more than one member, the height of the workbench-table can be adjusted when vertical support members are detached in order to reduce the height of the vertical support legs.

### BRIEF SUMMARY OF THE INVENTION

The novel invention presented herein, addressing the task of creating a multipurpose portable workbench-table comprised of a top and bottom section interconnected by detachable and rotatable vertical support legs; also, vertical support legs comprised of an upper and lower members; height adjustable flanges attached to the sides of top section that are comprised of horizontal and vertical members perpendicular to each other and having an L shaped configuration rotated 90-degrees counterclockwise. Another novel feature of the workbench-table is its capability to securely hold workpieces when flanges are horizontally separated from the workbench-table top section and workpieces are inserted in the gap created between the flanges and the workbench-table top section. Further, workpieces can also be secured when the horizontal section of the flanges are facing toward the center of the surface of the workbench-table top section are raised above the surface of the top section and workpieces are inserted between the surface of the top section and the bottom surface of the flanges' horizontal member.

In addition, workpieces can also be secured, to prevent workpieces from moving, by tightening C Clamps or a similar clamping mechanism between the workpieces and flanges. Also part of the novel design is the way in which the bottom section makes 100% contact with the ground and the vertical support legs comprised of upper and lower members makes it possible to create a portable, compact and structurally superior workbench-table than previously existing workbenches. Another unique feature of this workbench-table is that it collapses into a closed configuration when its pivoted vertical support legs, connected to the inside surface of the top section, rotate upwards toward the inside surface of the top section, and the pivoted vertical support legs connected to the inside surface of the workbench-table bottom section rotate downwards toward the inside of the bottom section.

### BRIEF DESCRIPTION OF DRAWINGS

FIG. 1 shows a perspective view of the main components of the novel workbench-table.

FIG. 2 shows a perspective view highlighting only the top and bottom sections.

FIG. 3 shows a perspective view of the vertical support legs of the novel workbench-table.

FIG. 4 shows a perspective and detailed views of methods to interconnect the upper and lower members of the vertical support legs.

FIG. 5 shows a perspective and exploded view of the flanges and horizontal members connected to the sides of the top section.

FIG. 6 shows a perspective view of a workpiece secured between the flange and a side of the top section.

FIG. 7 shows a perspective view of two workpieces secured between flanges and top surface of the top section and flanges raised above the plane of top section.

FIG. 8 shows a perspective view of a workpiece secured between a C-Clamp and flange.

FIG. 9 shows a perspective view of a workpiece secured between two C-Clamps and flanges.

FIGS. 10a and 10b show a perspective view of top section with support legs in the storage position and the bottom section containing support legs in the storage position.

FIGS. 11a and 11b shows a perspective view of the vertical support legs in a semi-rotated position in a direction towards the inside surface of the top section and towards the inside surface of the bottom section.

FIG. 12 shows a perspective view of both the top and bottom sections in a closed configuration locked by the latch mechanism.

### DETAILED DESCRIPTION OF THE INVENTION

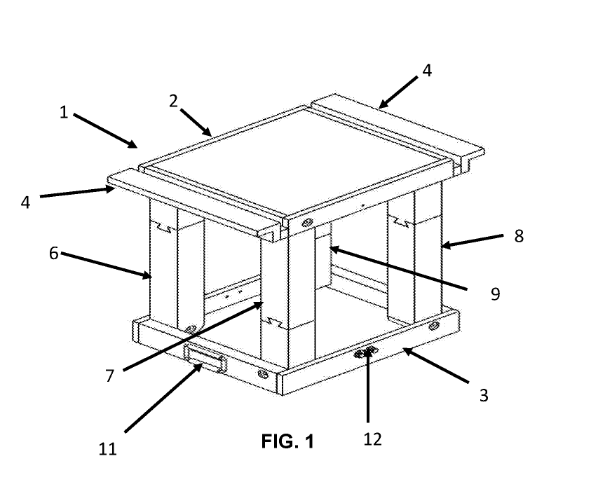

Referring now to FIG. 1 through FIG. 12, shown is the novel portable workbench-table. FIG. 1 shows the workbench-table comprised of top section 2, bottom section 3, flanges 4, vertical support legs 6, 7, 8, and 9, handle 11, and latch 12.

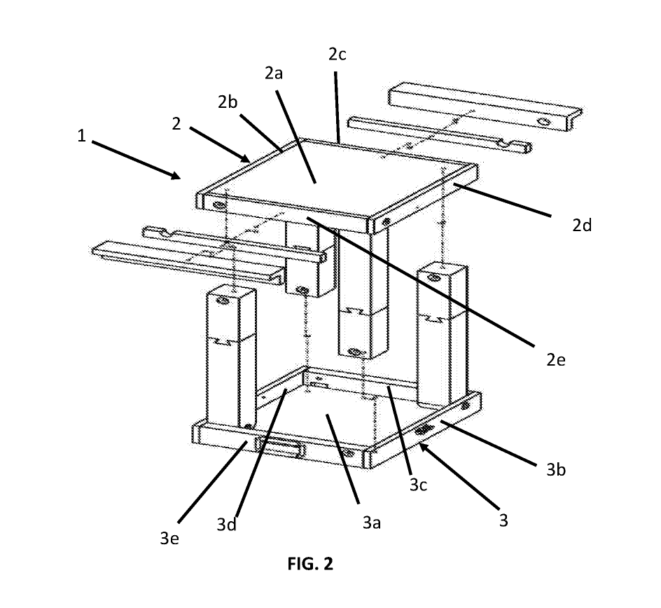

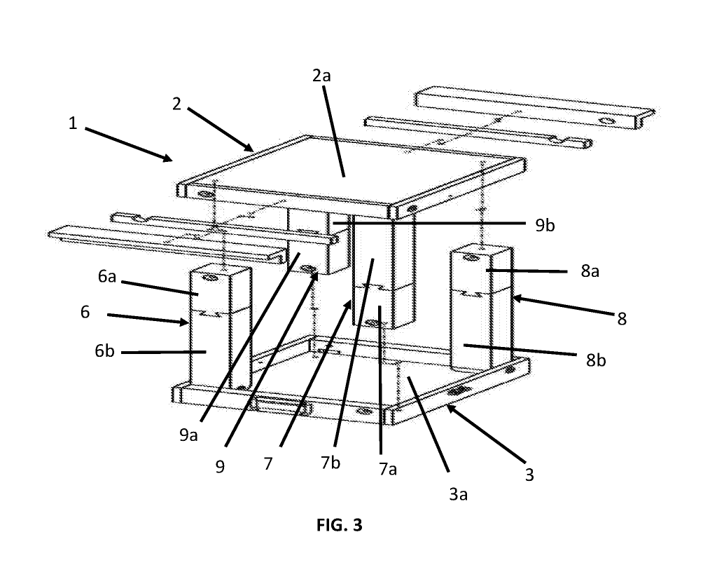

Further, FIG. 2 illustrates top section 2 comprised of top member 2a enclosed by perimeter members 2b, 2c, 2d, and 2e; and bottom section 3 comprised of bottom member 3a enclosed by perimeter members 3b, 3c, 3d, and 3e. In addition, FIG. 3 shows pivoted, detachable and rotatable vertical support legs 7 and 9 connected to the inside surface of top member 2a wherein upper members 7b and 9b are pivoted on the inside surface of member 2a of top section 2 and can rotate, at their pivot, upwards towards the inside surface of member 2a of top section 2; and pivoted and rotatable vertical support legs 6 and 8 connected to the inside surface of bottom member 3a wherein lower members 6b and 8b are pivoted on the inside surface of bottom member 3a and can rotate, at their pivot, downwards towards the inside surface of bottom member 3a of bottom section 3.

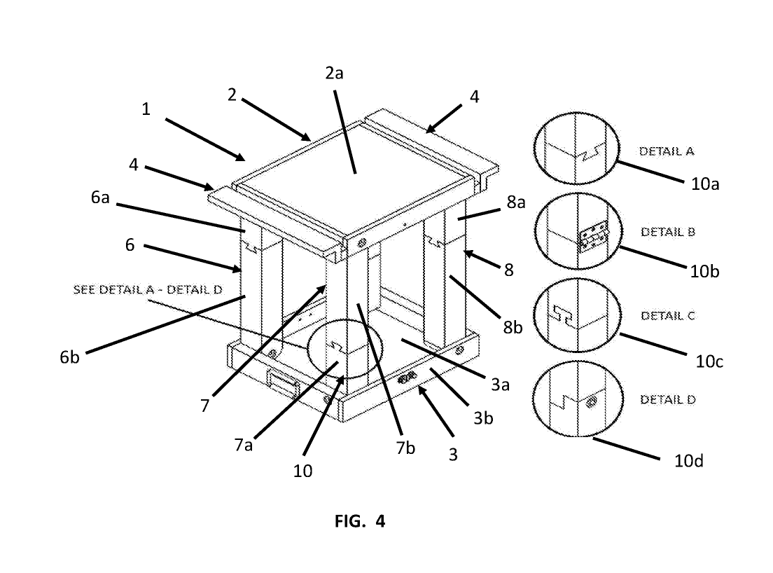

Also, FIG. 4 shows a perspective view of vertical support leg connection detail 10 of upper support member 7b and lower support member 7a wherein enlarged detail view 10a (dovetail), 10b (hinge), 10c (t-slot), and 10d (joint) illustrate alternate methods to connect upper and lower support members of vertical support legs, such that connection methods allow the upper support members to be easily disconnected from the lower support members.

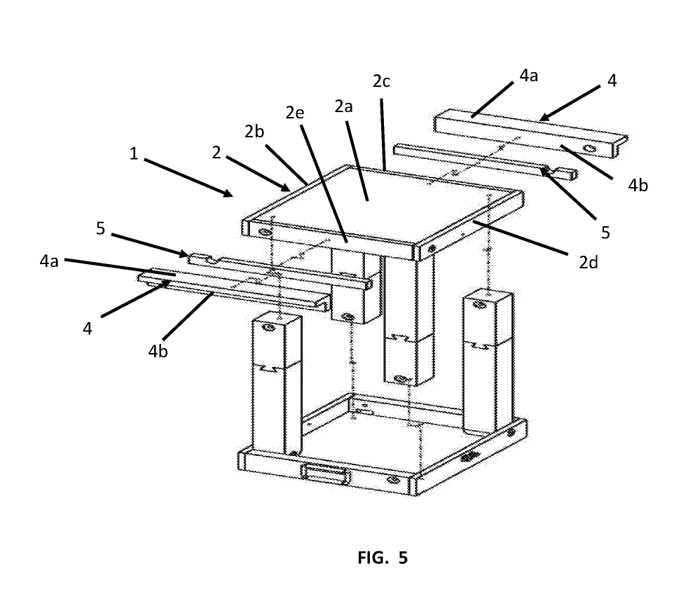

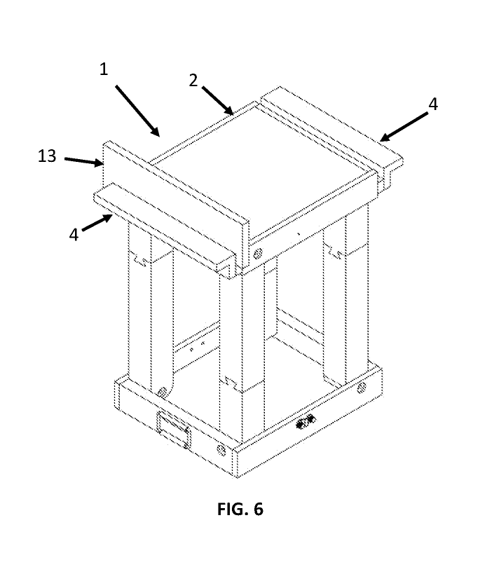

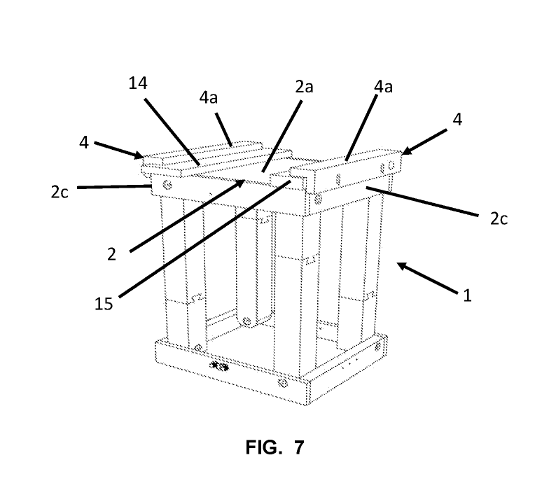

FIG. 5 shows an exploded view of flange 4 attached to sides 2e and 2c and comprised of horizontal member 4a and vertical member 4b. This figure also illustrates detachable horizontal members 5 attached to sides 2e and 2c respectively. FIG. 6 shows workpiece 13 being secured between flange 4 and side 2c of top section 2. FIG. 7 shows workpiece 14 and 15 being secured between horizontal member 4a of flange 4 which is raised above the plane of top section 2.

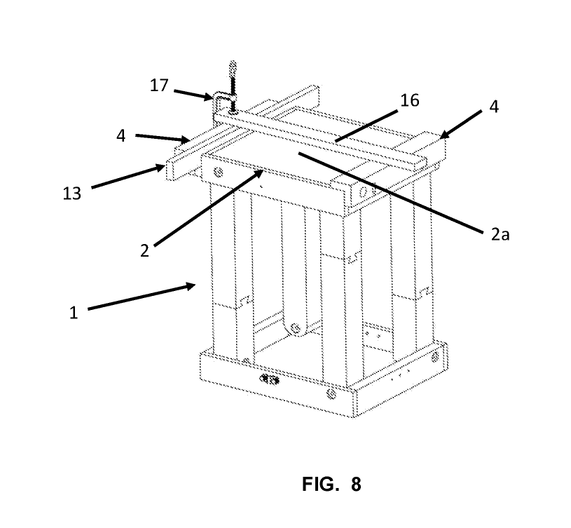

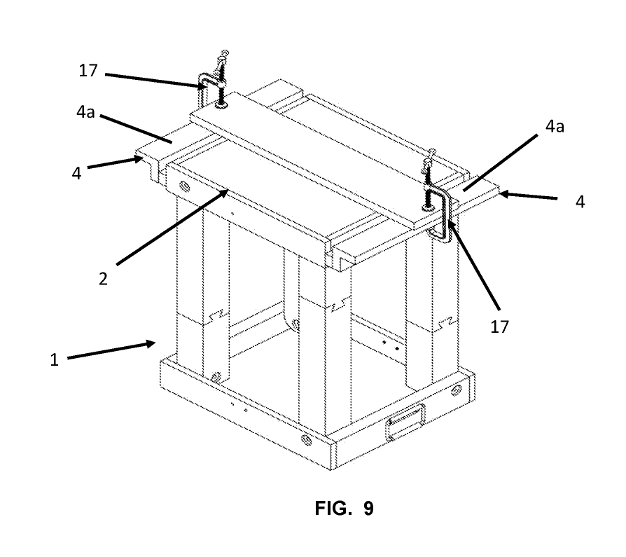

FIG. 8 shows workpiece 13 being secured between C-Clamp 17 and flange 4. FIG. 9 shows workpiece 18 being secured between C-Clamps 17 and horizontal members 4a of flange 4.

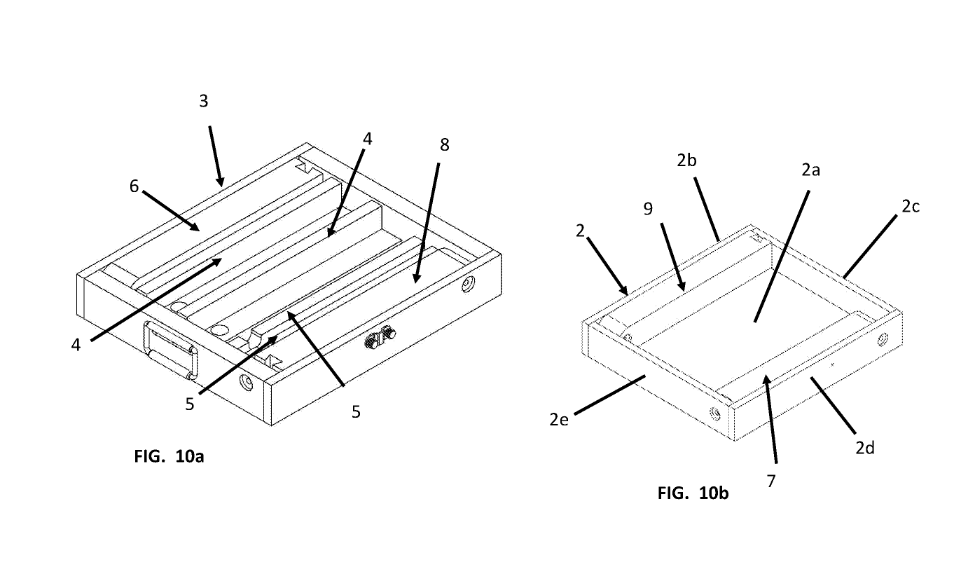

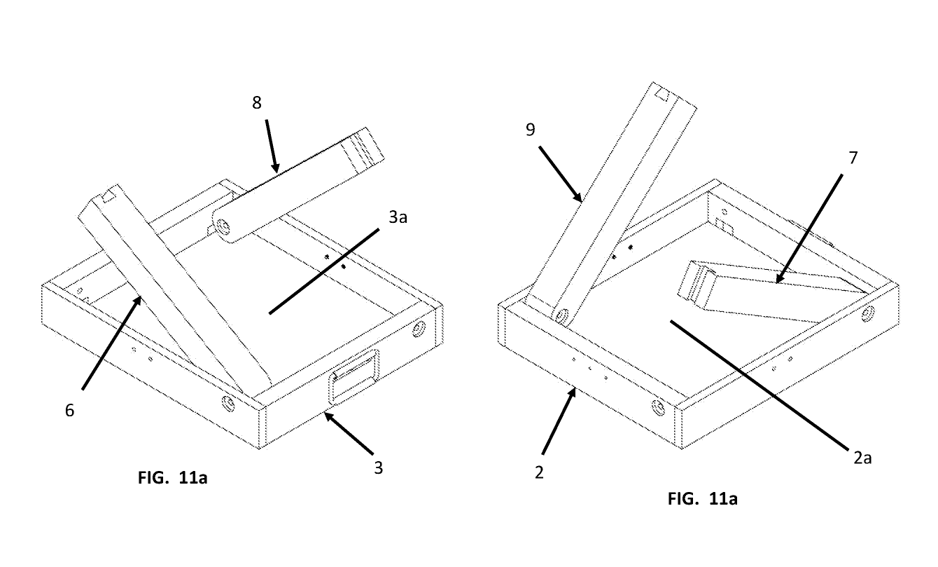

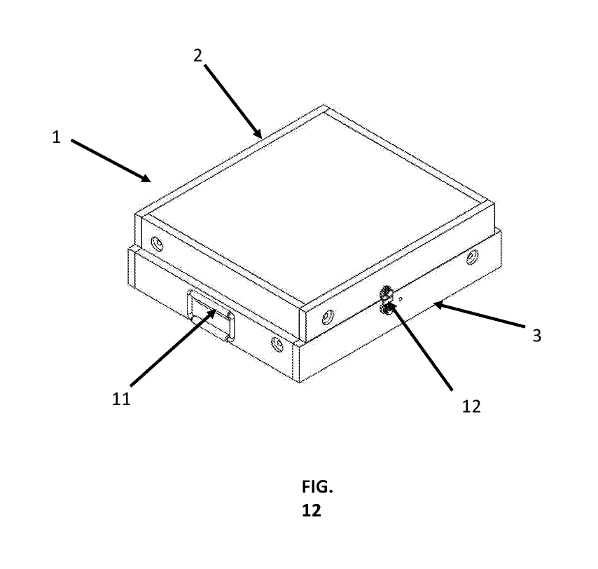

Furthermore, FIG. 10a illustrates vertical support legs 6 and 8 rotated 90-degrees, into support legs storage position, downwards towards the inside surface of member 3a of bottom section 3; flanges 4 are also placed between support legs 6 and 8 on the inside surface of member 3a of bottom section 3; FIG. 10b shows top section 2 rotated 180 degrees and vertical support legs 7 and 9 rotated 90-degrees into support legs storage position, downwards towards the inside surface of member 2a of top section 2. Further, FIG. 11a identifies vertical support legs 6 and 8 partially rotated downwards towards the inside surface of member 3a of bottom section 3 and FIG. 11b shows top section 2 rotated 180-degrees and vertical support legs 7 and 9 shown partially rotated upwards towards the inside surface of member 2a of top section 2. And, FIG. 12 identifies the unique workbench-table in a closed configuration with latch 12 in locked position.

I claim:

1. A main workbench-table, with detachable and rotatable members; said workbench-table comprising a top section, bottom section, detachable and rotatable side flanges, detachable and rotatable vertical support members, detachable horizontal members, handle and latch; said top section of said workbench-table comprised of top member enclosed by perimeter top sides members; said top members having inside and outside surfaces; said bottom section comprised of bottom member enclosed by perimeter bottom sides members; said bottom member having inside and outside surfaces; said top and bottom sections of said workbench-table interconnected by said vertical support members; said vertical support members having one end pivoted and one end not pivoted; said pivoted ends of said vertical support legs connected to said inside surface of said top member of said top section rotate upwards towards said inside surface of said top section; said pivoted ends of said vertical support legs connected to said inside surface of said bottom section rotate downwards towards said inside surface of said bottom section; said detachable and rotatable flanges attached to said top sides of said top section; said detachable horizonal members attached to sides of said top section.
